(19) United States
(12) Patent Application Publication
(10) Pub. No.: US 2012/0091289 A1
(43) Pub. Date: Apr. 19, 2012

(54) WIRE AND CATHETER RETENTION DEVICE

(76) Inventor: Wendy M. Tomlinson, La Grange, GA (US)

(21) Appl. No.: 13/210,406

(22) Filed: Aug. 16, 2011

Related U.S. Application Data
(60) Provisional application No. 61/374,352, filed on Aug. 17, 2010.

(51) Int. Cl. F16L 3/10

(52) U.S. Cl. 248/65

(57) ABSTRACT

A device for organizing wire or tubing comprising a base having top and bottom surfaces; at least one retention member associated with and raised above the plane of the base. The retention member has a first side, second side, and an upper surface, a slit defined between the first and second side, the slit having upper and lower openings, the upper opening extending from the upper surface toward the base, the lower opening extending to a horizontal channel defined between the first and second sides. The channel has a larger diameter than the width of the slit lower opening. The first and second sides of the retention member have sufficient deformability so as to be separable to enable the width of the slit to be increased to permit insertion of at least one length or loop of wire or tubing into the slit and into the channel.

### CROSS-REFERENCE TO RELATED APPLICATION

This application claims benefit of copending U.S. provisional patent application No. 61/374,352, filed Aug. 17, 2010, entitled Sterile Intravascular Wire, Catheter and Equipment Retention Device, and commonly assigned to the assignee of the present application, the disclosure of which is incorporated by reference in its entirety herein.

### FIELD

The present disclosure relates to devices for removably retaining loops of wire or tubing in an organized manner.

### BACKGROUND

Catheterization and vascular procedure labs commonly use towels and sheets to hold articles, such as catheter wires, tubes, and the like, on the procedure table. These wire or tube-like articles may initially be set up on the table in set of loops, which must be held in position to avoid the material memory which can cause the article to revert to a relatively straight length. Such articles may become hidden between layers of towels, making it difficult to see what articles are available and to have ready access to them. Furthermore, such articles are often rendered unusable because they become contaminated when attempts are made to find and free the articles from the towels that are holding multiple articles.

It would be desirable to have an apparatus which provides ready access to such articles while organizing and maintaining them in a desired configuration (for example, a series of loops). It would be desirable to have an apparatus which would allow articles to be held in a desired orientation and be easily removable.

### SUMMARY

One exemplary embodiment of the present disclosure provides a device for organizing and managing loops or segments of wire or tubing in an operating room environment comprising a generally planar base having a top surface and a bottom surface; at least one retention member associated with and raised above the plane of the base top surface and comprising a first side, a second side, an upper surface, a slit defined between the first and second side, the slit having an upper opening and a lower opening, the upper opening extending from the upper surface toward the base, the lower opening extending to a generally horizontal channel defined between the first and second sides, the channel having a larger diameter than the width of the lower opening of the slit, wherein the first and second sides of the retention member have sufficient deformability so as to be separable to enable the width of the slit to be increased to permit insertion of at least one length or loop of wire or tubing into the slit and into the channel.

Other features will become apparent upon reading the following detailed description of certain exemplary embodiments, when taken in conjunction with the appended claims.

### BRIEF DESCRIPTION OF THE DRAWINGS

The drawings disclose exemplary embodiments in which like reference characters designate the same or similar parts throughout the figures of which:

FIG. 1 is a perspective view of a first exemplary embodiment of the present disclosure.

FIG. 2 is a perspective view of a variation of the first exemplary embodiment showing several retention devices on a single base.

FIG. 3 is a perspective view of a second exemplary embodiment of the present disclosure.

FIG. 4 is a perspective view of a third exemplary embodiment of the present disclosure having a first exemplary configuration of a plurality of slits 336, 337.

FIG. 5 is a perspective view of a fourth exemplary embodiment of the present disclosure having a second exemplary configuration of a plurality of slits 446, 447, and 448.

### DETAILED DESCRIPTION

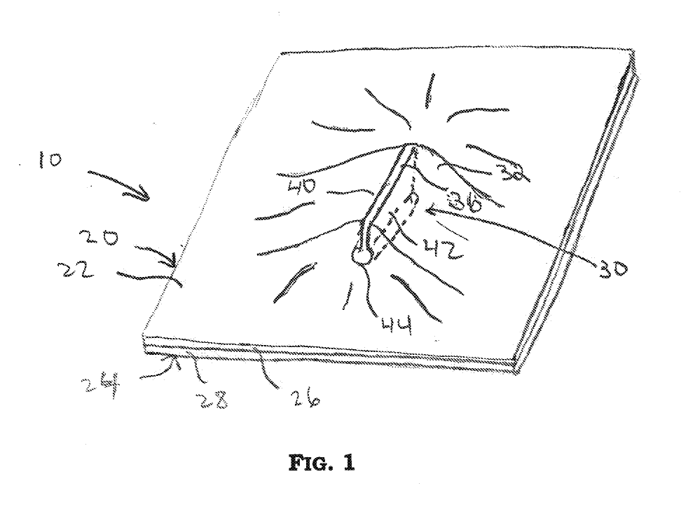

FIG. 1 shows a first exemplary embodiment of a retention device 10 having a base 20 which may be generally flat. The base may be made of a flexible or rigid material. Flexible materials include, but are not limited to, fabric (woven, nonwoven or blends or mixtures thereof), plastic, metal, composite, wire, cellulose, wood-based products, paper, synthetic, rubber, mesh, mixtures and combinations thereof and the like. Rigid materials include, but are not limited to, plastic, metal, ceramic, wood, fiberboard, composite, mixtures and combinations thereof and the like. The base may comprise a single layer, multiple layers or a laminate of any of the foregoing materials. In one exemplary embodiment the base may comprise a sheet of felt-like fabric. In one exemplary embodiment the base material is capable of being sterilized. In one exemplary embodiment the base material is made of a bioinert material. In one exemplary embodiment the base material may be treated with a microbiocide or antimicrobial composition.

The base has a top surface 22 and a bottom surface 24. In one exemplary embodiment the base comprises a first base material layer 26 and a second base material layer 28. A holder 30 may be sandwiched between the two layers 26, 28. The holder 30 may be made of a deformable material, such as, but not limited to, rubber, foam, Styrofoam, plastic, or the like. The holder 30 may have a generally dome-shaped upper surface 32 and a flat bottom surface 34 (not shown). The upper surface 32 has a slit 36 extending generally vertically downward toward the holder bottom surface 34. The slit 36 may be straight, curved, angled, undulating, jagged or other shape. The slit 36 is defined by first side wall 40 of the holder and a second side wall 42 of the holder. The slit 36 extends through the first base material layer 26. A generally horizontal channel 44 is formed in the base 20, which includes the first base material layer 26 and the holder 30. In one exemplary embodiment the channel 44 is raised above the height corresponding to the edges of the base 20. The channel 44 has a diameter greater than the width of the slit 36 opening as measured from the edge of the first to the edge of the second side. By deformable it is meant that the first and second side walls 40, 42 proximate to the slit 36 can be separated slightly by force, thereby widening the width of the slit 36.

In another exemplary embodiment the base may be formed of a single layer of material having variable thickness, the thickness increasing from the edges toward the center of the base top surface. In one exemplary embodiment the thickening shape provides a dome-shaped appearance. In this exemplary embodiment the base bottom surface is generally flat.

The slit may be foil led by laser cutting, knife, hot wire, poured into a mold or other conventional slit-creating technique. The channel may be similarly formed.

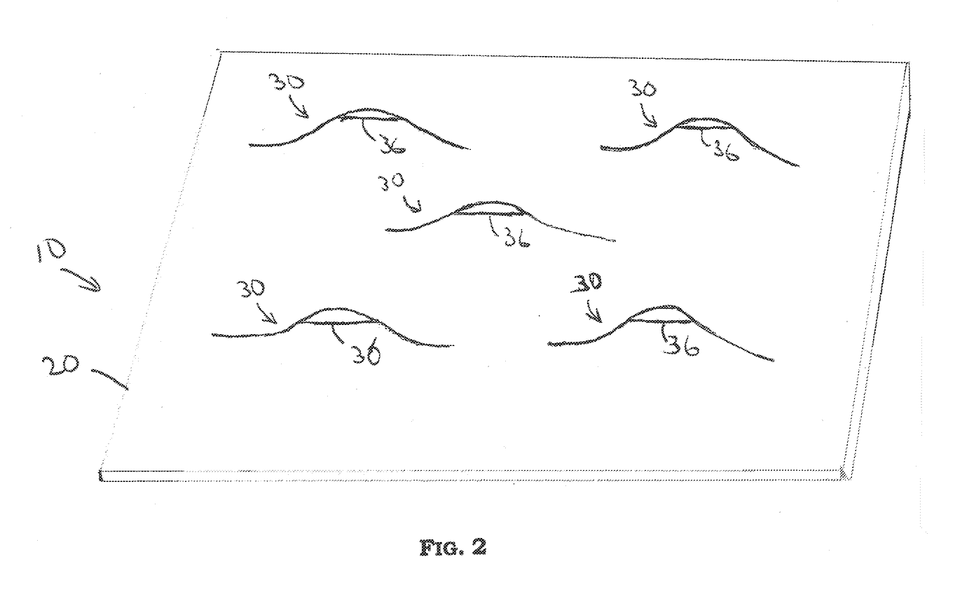

FIG. 2 shows a variation on the first exemplary embodiment in which the device 10 includes several holders 30 spaced apart and incorporated into the base 10.

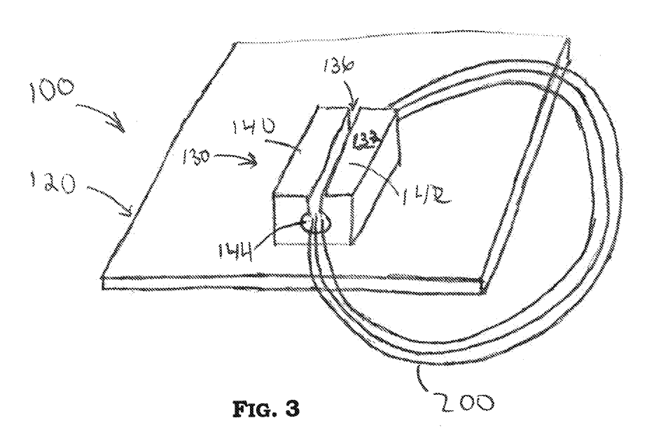

In a second exemplary embodiment, shown in FIG. 3, a retention device 100 has a base 120 which may comprise a generally flat single first layer of material (it being understood that the first layer may comprise a single sheet, multiple sheets, a laminate of layers, or the like). A holder 130 may comprise a block of material. The holder 130 may be generally parallelepiped-shaped, cubic, hemispherical, or other regular or irregular shape. The holder 130 has a top surface 132 and a bottom surface 134 (not shown). The holder 130 has a slit 136 formed therein extending generally from the top surface 132 toward, but not reaching, the bottom surface 134. The slit 136 is defined by a first side wall 140 and opposing second side wall 142 of the holder. A generally horizontal channel 144 is formed in the holder 130 such that the bottom of the slit and the channel 144 form a continuous opening. The diameter of the channel 144 is greater than the width of the slit 136. In this embodiment the holder 130 may be affixed, either permanently or removably, to the base 120. If removably, the base 120 may be attached by any conventional attachment mechanism, such as, but not limited to, hook and loop fastener, hooks, buttons, snaps, adhesive, and the like.

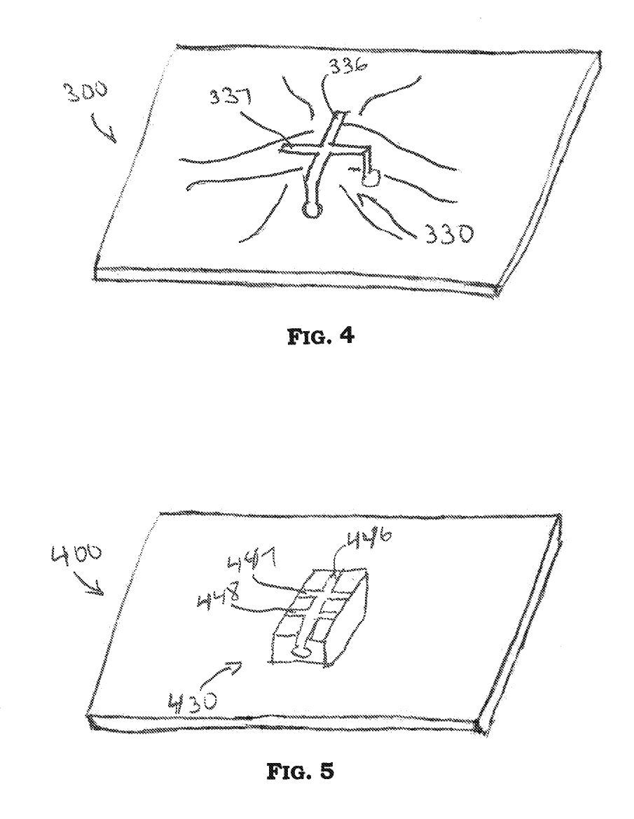

In a third exemplary embodiment, shown in FIG. 4, a holder may be adapted to have a plurality of slits. FIG. 4 shows an embodiment in which the device 300 has a holder 330 having two perpendicular slits 336, 337. FIG. 5 shows a fourth exemplary embodiment in which a device 400 has a holder 430 several slits 446, 447, and 448. The multiple slits can enable the device to hold more than one item, or to hold an item in either of at least two orientations.

Items which may be inserted into the device include, but are not limited to, wire, tubing, balloons, catheters, fabric, and the like. Wire and tubing, for example, may be a short length or a number of loops. In operation, using the first embodiment illustrated in FIGS. 1-2 as an example, a user grasps the item 200 to be inserted and presses it down into the slit 36. The first and second side walls 40, 42 deform or flex slightly in the sense that they separate to increase the size of the slit 36 gap, thereby permitting the item 200 to be inserted. The item 200 is inserted down into the slit 36 and into the channel 44. Since the channel 44 has a diameter greater than the width of the slit 36, the item 200 inserted generally clears the slit 36 and is held in the channel 44. The first and second side walls 40, 42, no longer being urged away from each other, deform or flex back to generally their original orientation, thereby causing the slit 36 gap to recover to generally its original width. This results in the item 200 held in the channel 44 to be retained therein as the slit 36 gap blocks the item 200 from being accidentally removed from the holder 30. When a user wants to remove the item 200, the user grasps the item 200 and pulls it upward, causing the side walls 40, 42 to flex and create a sufficiently wide gap in the slit 36 to permit the item 200 to move up through the slit 36 and to be removed.

The flexible or deformable construction of the holder permits the item 200 to be held, yet not itself deformed. Where the item 200 is a series of loops of wire (which, left unfettered, would tend to straighten into a straight length), the retention device 10 can hold the loops in the desired orientation, preventing the wire from straightening out and becoming unwieldy. In a catheterization procedure room, where typically the physician uses a number of items 200, such as wires, catheters and tubes, each being a generally straight length or a series of loops, the retention device of the present disclosure can hold the various items in a neat and organized condition until needed. The retention device permits easy removal while securely holding the items. The retention device can be laid out on or partially draped over a patient or a nearby table. The retention device can be rendered sterile. The top surface 22 of the base 20 can be formed so that it can be printed on, such as by using a pen or marker to indicate what size wire is being held by a particular holder 30.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

While the methods, equipment and systems have been described in connection with specific embodiments, it is not intended that the scope be limited to the particular embodiments set forth, as the embodiments herein are intended in all respects to be illustrative rather than restrictive.

As used in the specification and the appended claims, the singular forms “a,” “an” and “the” include plural referents unless the context clearly dictates otherwise.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

It should further be noted that any patents, applications and publications referred to herein are incorporated by reference in their entirety.

What is claimed is:

1. A device for organizing and managing loops or segments of wire or tubing in an operating room environment, comprising:
a) a generally planar base having a top surface and a bottom surface;
b) at least one retention member associated with and raised above the plane of the base top surface and comprising a first side, a second side, an upper surface, a slit defined between the first and second side, the slit having an upper opening and a lower opening, the upper opening extending from the upper surface toward the base, the lower opening extending to a generally horizontal channel defined between the first and second sides, the channel having a larger diameter than the width of the lower opening of the slit,
wherein the first and second sides of the retention member have sufficient deformability so as to be separable to enable the width of the slit to be increased to permit insertion of at least one length or loop of wire or tubing into the slit and into the channel.

2. The device of claim 1, wherein the at least one retention member comprise a generally parallelepiped-shaped block.

3. The device of claim 2, wherein the block is associated with the base top surface by a fastener selected from the group consisting of glue, pressure sensitive adhesive, removable adhesive, matable hook and loop fastener, barbs, suction cup, snap, hook, button, tab and slot, bolt, and combinations of the foregoing.

4. The device of claim 2, wherein the first and second sides are integrally formed with the base and extend upward from the top surface of the base and the slit extends between the first and second side from the upper surface toward the base.

5. The device of claim 1, wherein the at least one retention member comprises a hill-like sloped protrusion extending upward from the base top surface.

6. The device of claim 1, wherein the retention member further comprises at least one second slit disposed generally perpendicular to the slit.

7. The device of claim 1, wherein the at least one retention member comprises a plurality of retention members spaced apart on and associated with the top surface of the base.

8. The device of claim 1, wherein the base top surface can accept printing from a marking implement.

9. The device of claim 1, wherein the bottom surface of the base includes gripping means for reducing sideways movement of the base when positioned on a table or other surface.

10. The device of claim 9, wherein the gripping means comprises a fastener selected from the group consisting of glue, pressure sensitive adhesive, removable adhesive, matable hook and loop fastener, barbs, suction cup, snap, hook, button, bolt, slip-resistant material, and combinations of the foregoing.
